(19) United States
(12) Patent Application Publication
(10) Pub. No.: US 2003/0203252 A1
(43) Pub. Date: Oct. 30, 2003

(54) Fuel cell system using emulsified fuel

(76) Inventors: Paul J. Berlowitz, Glen Gardner, NJ (US); Bruce R. Cook, Stewartsville, NJ (US); John L. Robbins, Stockton, NJ (US); Jack W. Johnson, Clinton, NJ (US); Richard J. Bellows, Hampton, NJ (US)

Correspondence Address: ExxonMobil Research and Engineering Company, P.O. Box 900, Annandale, NJ, 08801-0900, US

(21) Appl. No.: 10/412,190

(22) Filed: Apr. 11, 2003

Related U.S. Application Data
(63) Continuation of application No. 09/791,996, filed on Feb. 23, 2001.
Application No. 09/791,996 is a continuation of application No. 09/312,728, filed on May 14, 1999, now abandoned.

(51) Int. Cl. H01M 8/06

(52) U.S. Cl. 429/19; 429/17; 429/20

(57) ABSTRACT

The present invention includes a fuel cell system and a method to operate a fuel cell. The fuel cell system includes a source of a fuel and water emulsion, receiving the emulsion and. a reformer for receiving the emulsion and producing hydrogen, a hydrogen-oxygen fuel cell connected to the reformer and able to receive hydrogen from the reformer. The method for operating a fuel cell system including a hydrogen gas oxygen fuel cell includes producing the hydrogen gas from a fuel and water emulsion.

### FUEL CELL SYSTEM USING EMULSIFIED FUEL

This is a Continuation of U.S. Ser. No. 09/791,996 filed Feb. 23, 2001, which is a Continuation of U.S. Ser. No. 09/312,728 filed May 14, 1999 based on Patent Memorandum 98CL-028.

### BACKGROUND OF THE INVENTION

The present invention is directed to an improved fuel cell system. In particular, the fuel cell system includes hydrogen-oxygen fuel cell in which the source of the hydrogen gas is a fuel and water emulsion. There is a recognized need to reduce emissions from internal combustion engines. Fuel cells provide a potential long term solution to the problem of regulated emissions and are currently considered more viable than many other potential emission solutions. One of the solutions to gaseous emissions that include fuel cells requires that the vehicles include the fuel cell system. One of the more difficult aspects of engineering any fuel cell system utilizing a fuel reformer is the management of water which must be present in the fuel processor for partial oxidation and/or steam reforming and/or water gas shift, and thus must conventionally be stored on-board for start-up, and recycled from the fuel cell stack effluent via condensation.

Onboard water storage and use presents many problems such as freezing during cold weather. Also, heat exchangers and water recovery systems are necessary and increase the cost and complexity of the system. What is needed in the art is a fuel cell system capable of alleviating these problems.

### SUMMARY OF THE INVENTION

The present invention includes a fuel cell system and a method to operate a fuel cell.

The fuel cell system includes a source of a fuel and water emulsion, a reformer for receiving the emulsion and producing hydrogen, a hydrogen-oxygen fuel cell connected to the reformer and able to receive hydrogen from the reformer. The method for operating a fuel cell system including a hydrogen-oxygen fuel cell includes producing the hydrogen from a fuel in water emulsion.

### BRIEF DESCRIPTION OF THE FIGURES

FIG. 1 depicts a typical prior art fuel cell system as herein described.

FIG. 2 depicts one version of the.fuel cell system of the instant invention.

### DETAILED DESCRIPTION OF THE INVENTION

The present invention is a fuel cell system and a method for operating a hydrogen-oxygen fuel cell wherein the fuel is in the form of a fuel and water emulsion. The emulsion may be a fuel in water or a water in fuel emulsion.

The present invention is particularly suitable for vehicle usage where onboard storage of water presents a large problem. However, the system may also be utilized in stationary applications. It is well known that methods exist to convert hydrocarbon and/or alcohol fuels into a H₂-rich gas for use in electricity generation via a fuel cell. Many of these methods cite the reaction of hydrocarbons and/or alcohols with oxygen (and/or oxygen containing gas such as air) and/or water at elevated temperatures to produce mixtures rich in H₂, CO₂, and N₂ with low levels of CO. For example, steam reforming, autothermal reforming, partial oxidation, or combinations of the above, etc., can be used. Indeed any method known to the skilled artisan for producing hydrogen from a hydrocarbon fuel can be utilized herein as the hydrogen generation means. For example, in the well-known steam reforming reaction, hydrocarbons or alcohols are contacted with water over a catalyst to produce a gaseous stream largely comprised of H₂ and CO₂, but also containing 0.5 to 20% (more typically 10 to 20%) CO. Carbon monoxide in the reformate gas stream inhibits the performance of the Polymer Electrolyte Membrane (PEM) Fuel Cell in producing electric power from the hydrogen gas. At concentrations higher than 1 mole percent, the CO component inhibits the performance of Phosphoric Acid Fuel Cells in the production of electric power from the hydrogen gas. For this reason, process flow schemes for fuel processor/fuel cell systems based upon steam reforming of a hydrocarbon and/or alcohol fuel typically incorporate a water-gas shift reaction step, wherein the product of steam reforming is combined with additional steam over a catalyst to convert most of the CO in the reformate to H₂ and CO₂ according to reaction 1.

CO+H₂O=CO₂+H₂ (1)

This process requires introduction of additional water, in the form of steam, either upstream of the steam reforming reactor, or at the inlet of the water gas shift reactor. There may be additional CO clean-up steps such as preferential oxidation, adsorption, membrane separation, and the like to reduce the CO level to acceptable concentrations for fuel cell operation. In the instant invention, the fuel and water emulsion is capable of supplying the necessary amount of water needed to perform the steam reforming and/or water gas shift reaction to decrease or eliminate the CO produced concomitantly with hydrogen production. Thus, the fuel cell system may further comprise a means for decreasing the amount of CO in the hydrogen rich product stream.

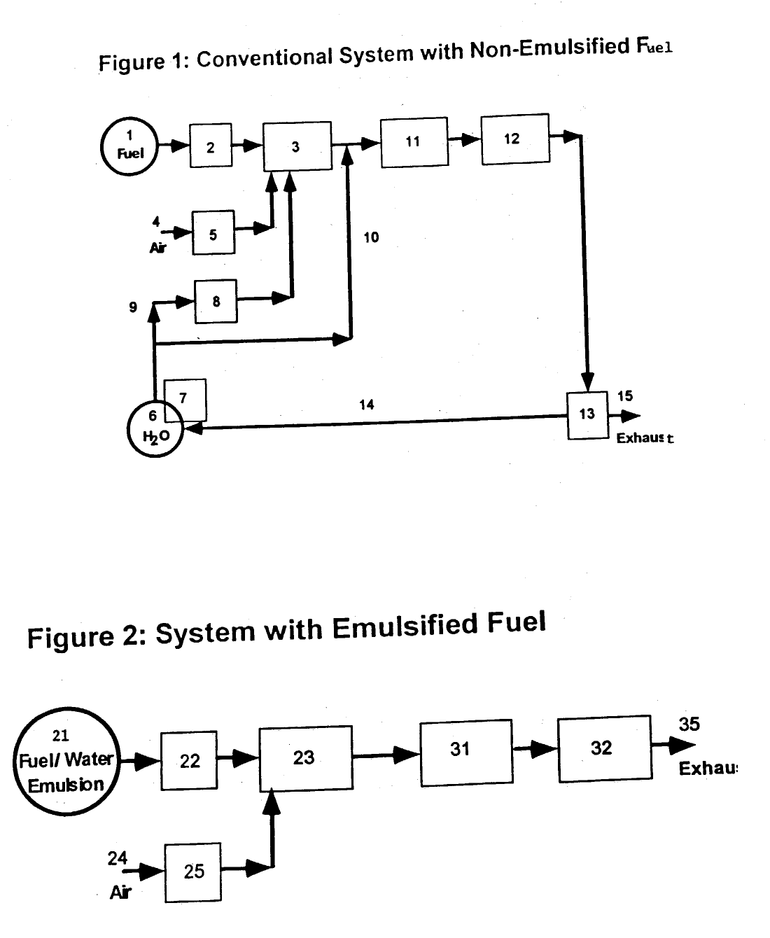

FIG. 1 shows a schematic of a typical prior art hydrogen generator based on a non-emulsified liquid fuel and using partial oxidation/steam reforming to convert the fuel into a syngas mixture. This system design is similar to that being developed by A. D. Little, except for the allowance of feeding water to the reformer to practice autothermal reforming. (Ref.: J. Bentley, B. M. Barnett and S. Hynek, 1992 Fuel Cell Seminar—Ext. Abs., 456, 1992.) The process in FIG. 1 is comprised as follows: Fuel is stored in a fuel tank (1). Fuel is fed as needed through a preheater (2) prior to entering the reformer (3). Air (4) is fed through preheater (5) and also introduced in the reformer (3). Water is stored in a reservoir tank (6). A heat exchanger (7) is integral with a portion of tank (6) and can be used to melt portions of the water if it should freeze at low operating temperatures. Some water from tank (6) is fed via Stream (9) to preheater (8) prior to entering the reformer (3). The reformed syngas product is combined with additional water from tank (6) via stream (10). This humidified syngas mixture is then fed to reactors (11) which perform water gas shift (reacting CO and water to produce more H₂ via reaction (1)) and CO cleanup. The H₂ rich-fuel stream then enters the fuel cell (12) where it reacts electrochemically with air (not shown) to produce electricity, waste heat and an exhaust stream containing vaporized water. A hydrogen-oxygen fuel cell as used herein includes fuel cells in which the hydrogen-rich fuel is hydrogen or hydrogen containing gases and the oxygen may be obtained from air. This stream is passed through a condenser (13) to recover a portion of the water vapor which is recycled to the water reservoir (6) via stream (14). The partially dried exhaust stream (15) is released to the atmosphere. Components 3 and 11 comprise a generalized fuel processor.

The instant invention describes an improved fuel cell system where the processor of said system stores, heats and supplies the water and fuel necessary for generation of hydrogen for powering the fuel cell as a fuel and water emulsion. Such a configuration solves many of the problems inherent in fuel processors, especially for fuel cell vehicle applications.

For example, use of the fuel and water emulsion 1) provides a reduced Reid Vapor Pressure (RVP) fuel compared to conventional naphtha or gasoline boiling materials which will reduce evaporative emissions which are the only significant source of hydrocarbon emissions from fuel cells. 2) Low sulfur fuels will reduce the need to clean up poisons in the process (a low sulfur fuel is preferred, e.g., a Fischer-Tropsch fuel, but is not a necessary requirement of the invention). 3) The water in the emulsion obviates the need to provide separate water supply during startup and water recovery during the process, simplifying and reducing the cost of the entire fuel cell system. 4) Fuel and water are simultaneously delivered and vaporized which simplifies the metering of the two liquids and reduces the complexity of the fuel pump/delivery system; and 5) one heat exchanger can be used for the emulsion, instead of separate exchangers for each of the fuel and water.

FIG. 2 shows a schematic of one possible configuration for the fuel cell system of the instant invention based upon a liquid fuel/water emulsion and using partial oxidation/steam reforming to convert the fuel into a syngas mixture. The process in FIG. 2 is comprised as follows: A fuel/water emulsion is stored in a fuel tank (21). Fuel is fed as needed through a preheater (22) prior to entering the reformer (23). Air (24) is fed through a preheater (25) and also introduced in the reformer (23). Sufficient water is present in the emulsion stored in tank (21). The syngas product continues on to additional reactors (31) which perform water gas shift and CO clean-up processing. The H₂-rich fuel stream then enters the fuel cell (32) where it reacts electrochemically with air (not shown) to produce electricity, waste heat and an exhaust stream containing vaporized water (35). The exhaust stream may be directly vented to the atmosphere without recovering water. Components 23 and 31 comprise a generalized fuel processor.

The process described in FIG. 2 is greatly simplified over the process described in FIG. 1. Heat exchanger (7) is no longer required to melt frozen water in reservoir (6) because the fuel/water emulsion in tank (1) can be formulated to remain in a liquid state at low operating temperature extremes. Tank (6), preheater (8) and streams (9) and (10) can be eliminated because sufficient water is contained in the fuel/water emulsion fed to preheater (2). The condenser for water recovery (13) can be eliminated because sufficient water is contained in the fuel/water emulsion in tank (1). Waste air from the fuel cell (15) can now be directly vented to the atmosphere without the need of additional water recovery processing.

The hydrocarbon fuel utilizable in the present invention is any fuel typically utilized in a fuel cell and capable of producing the necessary amount of hydrogen to power the fuel cell. Preferably, a low sulfur gasoline, naphtha, or other low sulfur, volatile, hydrocarbon fuel will be utilized. By low sulfur fuel is meant a fuel containing less than about 350, preferably less than 150 and, most preferably, less than 10 wppm sulfur. Even more preferably, a Fischer-Tropsch derived paraffin fuel boiling between C₄ and 700° F. and, more preferably, a naphtha boiling range material (C₅-C₁₀ primarily). In addition, the fuel can also include alcohols.

The emulsion may contain other agents such as water miscible or water immiscible alcohols to depress the freeze point, surfactants and/or anticorrosive agents. For applications where freezing may occur, the fuel preferentially contains an alcohol, preferably methanol or ethanol in a concentration sufficient to depress the freezing point to an acceptable limit. This is readily determinable by the skilled artisan.

The fuel and water emulsion will typically have a fuel to water ratio so that the number of moles of water compared to the number of moles of carbon contained in the hydrocarbon fuel would be about 0.5 to about 3.0. Higher ratios would be preferred for fuel and water emulsions containing greater than about 20 volume % alcohol, in particular methanol, preferably the ratio would be at least 1.0 to allow for the water gas shift of each mole of carbon forming carbon monoxide in partial oxidation and/or steam reforming to a mole of carbon dioxide and a mole of hydrogen, and most preferably the ratio would be about 1.0 to about 2.0. When other additives are included in the emulsion, the ratio will typically range from 0.5 to 3.0. Typically, when a surfactant is included in the fuel and water emulsion, the surfactant concentration will be less than 5 wt %, preferably less than 2 wt %, more preferably less than 1 wt%, and most preferably less than 0.5 wt % of the total emulsion weight. Such amounts are readily determinable by a formulator and are decided based upon factors such as ambient temperature effects on the emulsion. The amount of alcohol used can be readily determined from the known freezing points of alcohol and water solutions. This can be adjusted from nil alcohol for areas where there is no appreciable freezing threat to values below −40° C. for the most extreme winter environments.)

In addition to alcohols being added to the fuel and water emulsion herein described, a surfactant may additionally be added. The surfactant could be ionic or non-ionic, preferably non-ionic, more preferably containing only C, H, O or N, more preferably only C, H, and O. Typically, a surfactant such as an alkylated, ethoxylated phenol would be used. The hydrophilic lipophilic balance (HLB) for the surfactant is easily adjusted by one skilled in the art to provide for a stable emulsion. This will typically be a surfactant with an HLB of 3 to 20, more preferably 5 to 15. The emulsion can be produced by any of the known methods of shearing fuel, water and surfactant together so as to form a fuel and water emulsion. Those methods which produce more stable, small droplet emulsions are preferred.

It is evident to one skilled in the art that there are several alternative process integrations relative to the system schematics depicted in FIGS. 1 and 2. It is easily understood by one skilled in the art that several system components in FIGS. 1 and 2 are not explicitly shown, for example, various heat exchangers, pumps, compressors, expanders and as well as individual reactors such as water gas shift and CO cleanup reactors (11 and 31). It should be understood that the advantages claimed for using fuel/water emulsions are useful in these related process integrations and are not merely limited to the process schematic depicted in FIG. 2.

The overall system proposed is greatly simplified, does not require on-board water storage (which has freezing problems), and can be accomplished at a lower cost, space, and weight.

What is claimed is:

1. A fuel cell system comprising:
(a) a source of a fuel and water emulsion,
(b) a fuel reformer for receiving said emulsion and producing product including hydrogen gas,
(c) a hydrogen-oxygen fuel cell connected to said reformer and able to receive hydrogen from said reformer.

2. The fuel cell system of claim 1 wherein said source is a container which is capable of supplying said emulsion to said reformer.

3. The fuel cell system of claim 1 further comprising a water gas shift reactor between said reformer and said fuel cell.

4. The fuel cell system of claim 1 further comprising a water gas shift reactor between said reformer and said CO clean-up processor.

5. The fuel cell system of claim 1 further comprising a preheater for heating said emulsion before said emulsion enters said reformer.

6. The fuel cell system of claim 1 wherein said fuel is selected from the group consisting of alcohols which form emulsions with water, jet fuel, naphtha, gasoline, kerosene, Fischer-Tropsch derived liquids and mixtures thereof.

7. The fuel cell system of claim 1 wherein said fuel and water emulsion further comprises a freezing point depressant.

8. The fuel cell system of claim 1 wherein fuel and water emulsion is a fuel in water emulsion.

9. The fuel cell system of claim 1 wherein said fuel is a water in fuel emulsion.

10. The fuel cell system of claim 6 wherein said freezing point depressant is an alcohol.

11. The fuel cell system of claim 1 wherein said fuel and water emulsion further comprises a surfactant.

12. The fuel cell system of claim 1 wherein said surfactant is nonionic.

13. The fuel cell system of claim 1 wherein said surfactant only includes C, H, and O.

14. The fuel cell system of claim 1 further comprising a water recovery means from said fuel cell.

15. A method for operating a fuel cell system including a hydrogen-oxygen fuel cell comprising producing said hydrogen from a fuel and water emulsion.

16. The method of claim 10 wherein said fuel and water emulsion includes fuel and water in a ratio of about 0.5 to 3.0 moles of water per mole of carbon in said fuel and water emulsion.

17. The method of claim 11 wherein said fuel is selected from the group consisting of alcohols which form emulsions with water, jet fuel, naphtha, gasoline, kerosene, Fischer-Tropsch derived liquids and mixtures thereof.

18. The method of claim 11 wherein said fuel and water emulsion further comprises a freezing point depressant.

19. The method of claim 13 wherein said freezing point depressant is an alcohol.

20. The method of claim 11 wherein said fuel and water emulsion further comprises a surfactant.

21. The method of claim 15 further comprising the step of reforming said fuel and water emulsion to produce a product including hydrogen gas.

22. The method of claim 21 further comprising the step of processing said reformed fuel to remove CO.

23. The method of claim 21 further comprising the step of preheating said emulsion before said reforming step.
